(19) United States
(12) Patent Application Publication
(10) Pub. No.: US 2016/0084446 A1
(43) Pub. Date: Mar. 24, 2016

(54) Tubular LED Lamp

(71) Applicants: Richard Speer, Concord, MA (US); Bruce Radl, Stow, MA (US); Adam Scotch, Amesbury, MA (US)

(72) Inventors: Richard Speer, Concord, MA (US); Bruce Radl, Stow, MA (US); Adam Scotch, Amesbury, MA (US)

(73) Assignee: OSRAM SYLVANIA INC., Danvers, MA (US)

(21) Appl. No.: 14/860,978

(22) Filed: Sep. 22, 2015

Related U.S. Application Data
(60) Provisional application No. 62/054,017, filed on Sep. 23, 2014.

(51) Int. Cl. F21K 99/00; F21V 3/02; F21V 3/04; F21V 7/00

(52) U.S. Cl. CPC F21K 9/17; F21V 7/005; F21V 3/02; F21V 3/0445; F21Y 2101/02

(57) ABSTRACT

There is herein described an LED lamp comprising a tubular body having a diffuser portion and a circuit board portion. The circuit board portion has a plurality of light-emitting diodes mounted thereon and electric circuitry for providing power to the LEDs. In one embodiment, the circuit board and diffuser portions are integrally formed from a sheet of a translucent polymer. As the circuit board forms a part of the tubular body of the lamp, the LEDs are located at the circumference of the lamp instead of near the center. Such a configuration improves diffusion and distribution of the light. Moreover, since the circuit board is not contained within the tubular body, there is no enclosure to trap excess heat which is an additional advantage.

### CROSS REFERENCE TO RELATED APPLICATION

This application claims the benefit of U.S. Provisional Application No. 62/054,017 filed Sep. 23, 2014.

### BACKGROUND OF THE INVENTION

Standard linear fluorescent lamps are one of the most common lamp forms used to generate light. Given the large number of fluorescent fixtures installed in commercial, institutional, and industrial establishments, it is desirable to replace fluorescent lamps with other high efficiency, mercury-free lighting solutions having the same form factor so that replacement of the existing fixtures is not necessary. This has led to the development of solid-state replacement lamps which include linear arrays of light-emitting diodes (LEDs) on circuit boards disposed within hollow tubes. These new solid-state lamps require different construction methods than conventional fluorescent lamps and in particular novel techniques are required for mounting circuit boards with arrays of LEDs within the tubular lamp bodies.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1A is a cross-sectional view of a tubular LED lamp according to this invention.

FIG. 1B is a partial perspective view illustrating the insertion of the circuit board to form the lamp shown in FIG. 1A.

FIGS. 2A-2C illustrate the steps for forming another embodiment of a tubular LED lamp according to this invention.

FIGS. 3A and 3B illustrate a method of making the lamp shown in FIGS. 2A-2C.

### DETAILED DESCRIPTION OF THE INVENTION

In a typical LED retrofit solution for a conventional linear fluorescent lamp, a rigid circuit board is mounted to a length of an extruded aluminum heatsink which is disposed inside a translucent plastic tube. The LEDs direct light out through the translucent portion of the plastic tube. The extruded aluminum heatsink LED lamp is used for both mechanical support and thermal reasons. However, mounting the rigid circuit board to the aluminum extrusion tends to place the LEDs closer to the center of the tube which is less desirable for light diffusion and distribution. Additionally, light may be lost due to backscattered light rays which are not reflected forward by the circuit board or the aluminum extrusion. Ideally, the LEDs in a tubular lamp should be located at or near the surface of the tube opposite the front of the lamp. The further the LEDs are away from the diffusing surface, the better the light diffusion which helps eliminate “hot spots” caused by the directional nature of the light emitted by the LEDs.

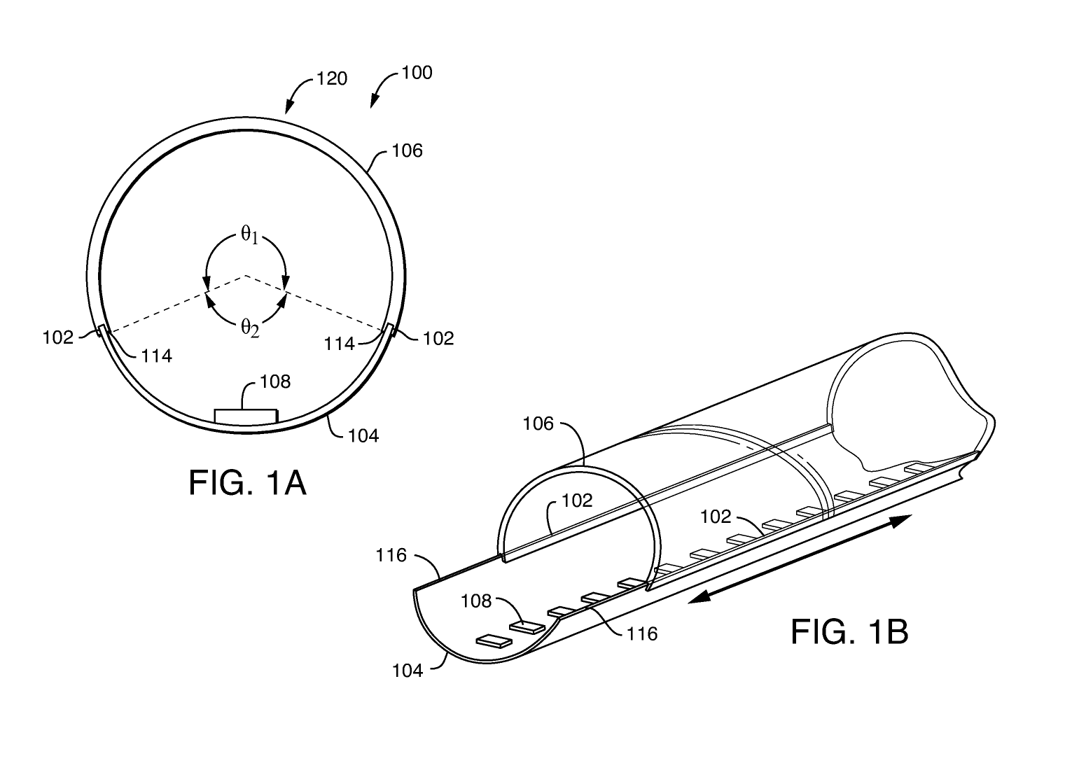

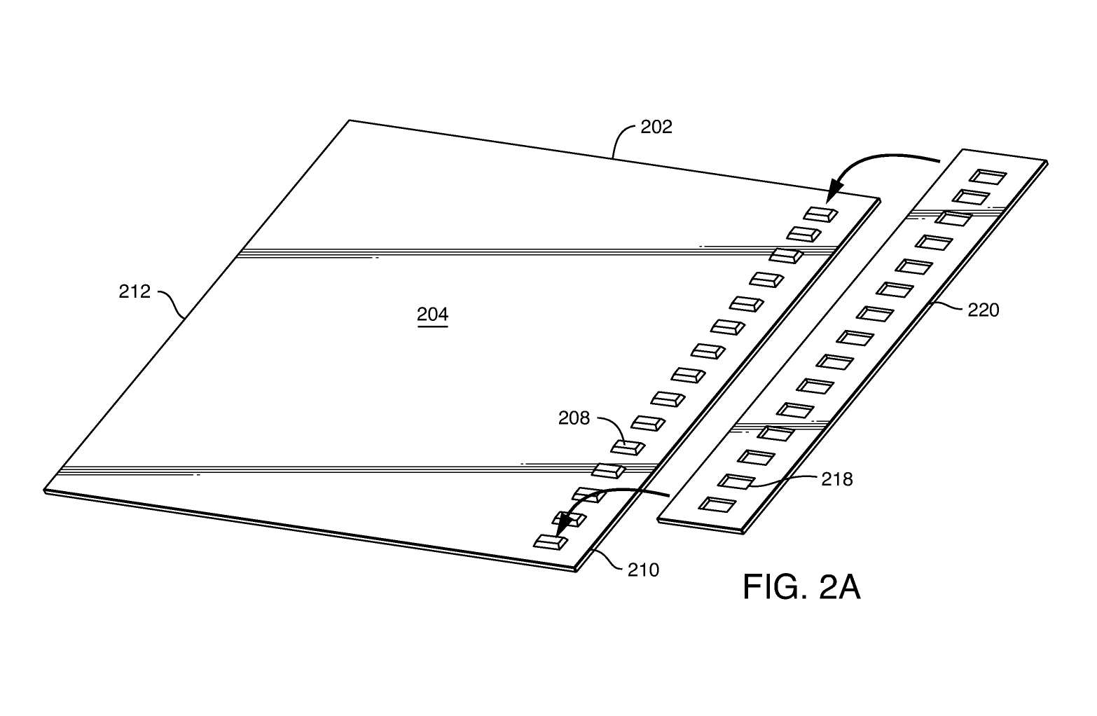

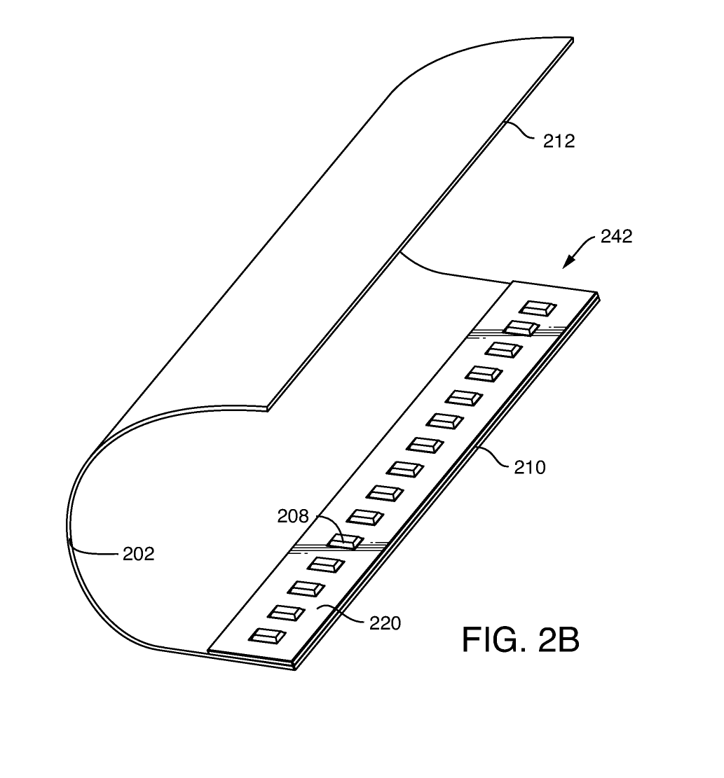

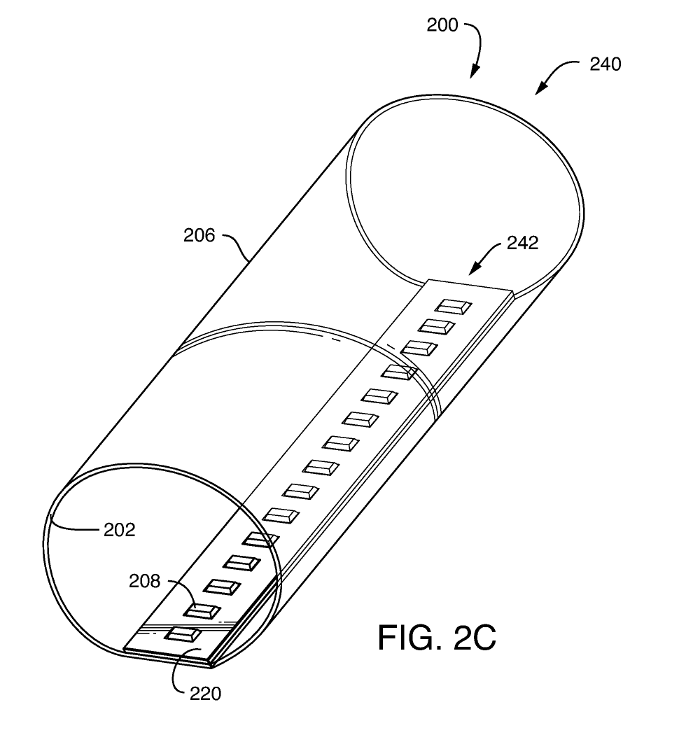

The present invention addresses the above-described problems of conventional retrofit LED lamps by utilizing a curved circuit board as part of the tubular body of the lamp. Preferably, the circuit board is thermoformed to have a curvature that is similar to the curvature of the desired tube, for example a linear T8 tube having a 1″ diameter. (The diameters of conventional linear fluorescent lamps are expressed in eighths of an inch, wherein a T5 lamp has a 5/8 inch diameter, a T8 lamp has a 1 inch diameter, and a T12 lamp has a 1½ inch diameter.) The circuit board may be formed separately from the diffuser portion of the tube as shown in FIGS. 1A and 1B or it may be integrally formed with the diffuser as shown in FIGS. 2A-2C. As the circuit board forms a part of the tubular body of the lamp, the LEDs are located at the circumference of the lamp instead of near the center. Such a configuration improves diffusion and distribution of the light. Moreover, since the circuit board is not contained within the tubular body, there is no enclosure to trap excess heat which is an additional advantage.

Referring now to FIGS. 1A and 1B, there is shown a first embodiment of the tubular LED lamp of this invention. The lamp 100 uses a highly reflective, circuit board 104 that has a curvature similar to the curvature of the tube. The high (>90%) reflectivity of the circuit board provides more recycled light and, because it is curved, the LEDs 108 are moved further away from the diffusing surface and front 120 of lamp 100 thereby rendering the light output more homogeneous. The tubular lamp body is formed by the combination of diffuser 106 and circuit board 104. Preferably, the diffuser 106 is formed of a translucent polymer material. The circuit board 104 has electric circuitry and contacts (not shown) for providing power to LEDs 108. The diffuser 106 is a partial tube having a cross section that is a circular arc that subtends a central angle θ₁. Similarly, the circuit board 104 has a cross section that is a circular arc that subtends a central angle θ₂. In this embodiment, the diffuser 106 and circuit board 104 are mated using longitudinal slots 102 in the longitudinal edges 114 of diffuser 106. The longitudinal edges 116 of circuit board 104 slide into the slots 102 as illustrated in FIG. 2A. When mated, the diffuser 106 and circuit board 104 form a tubular lamp body having a circular cross section. The portion of the tubular body comprised by circuit board 104 may vary in its fraction depending on the desired application. Preferably, θ₁ is an angle greater than 180° and more preferably θ₂ ranges from 120° to 150°. Even more preferably, the diffuser portion of the tubular body subtends a central angle of about 220° and the circuit board portion subtends a central angle of about 140°.

In a preferred embodiment, the circuit board 104 is comprised of a thermoformable polymer such as polyethylene terephthalate (PET) that has etched copper conductors laminated within the board. More particularly, the circuit board is formed by laminating a substrate of a thermoformable polymer material having etched copper conductors on its surface to a second sheet of thermoformable polymer in the form of a coverlay. The coverlay is preferably a highly reflective white PET with holes that allow for LEDs to be soldered to the copper conductors. The white PET coverlay is employed to reflect the light emitted by the LEDs towards the diffuser and front of the lamp. The use of a thermoformable material allows the conductors and LEDs to be placed on the circuit board prior to imparting the desired curvature to the board thereby simplifying manufacturing. In a preferred method, the circuit board 104 is first populated LEDs 108 by soldering the LEDs to the copper conductors. Next, the circuit board is placed in a mold having the desired cross-sectional shape. The mold is then placed in an oven and the board is heated at about 110° C. for about 20 minutes to achieve the thermoforming. Once cooled, the thermoformed circuit board is sufficiently rigid to maintain the shape of the tube.

The lamp 100 may be fitted with conventional fluorescent bi-pin ends caps (not shown) to provide an electrical interface that is compatible with existing fluorescent lamp fixtures. Additional electronics may also be provided within the tube or attached to one or both ends of the tube to provide AC-to-DC power conversion, current regulation, etc. As mentioned above, since the thermoformed circuit board forms a portion of the body, heat conduction away from the LEDs may be improved as there is no enclosure behind the LEDs to trap the heat as in other retrofit configurations. Moreover, the high reflectivity of the circuit board, the increased distance of the LEDs from the front of the LED lamp, and the large diffuser surface combine to produce an LED lamp with a high light output and an improved appearance.

With reference to FIG. 2A-2C, there is shown a second embodiment of a tubular LED lamp 200 according to this invention. In this embodiment, the circuit board and diffuser are an integral part of the tubular lamp body. In particular, the tubular body of the LED lamp is made from a single sheet of a translucent formable polymer material, such as PET, which also comprises the circuit board on which the LEDs are mounted. As shown in FIG. 2A, the circuit board is first formed from translucent polymer sheet 202. The translucent polymer sheet 202 has copper conductors (not shown) on surface 204 for providing electric power to the LEDs 208. The LEDs 208 are attached to the conductors at locations along one of the long edges 210 of sheet 202. A white PET coverlay 220 having openings 218 for the LEDs 208 is applied over the LEDs 208 covering a portion of the translucent sheet 202. Once laminated to sheet 202, the LEDs 208 protrude through the openings 218 in the coverlay 220. The diffuser portion 206 of the tubular lamp body comprises the portion of translucent sheet 202 that is not covered by coverlay 220.

After the coverlay 220 is laminated to the translucent sheet 202 to form the circuit board portion 242 of the tubular lamp body, the sheet 202 is then rolled into a tube and the two long edges 210, 212 of sheet 202 are attached to each other. The light emitted by LEDs 208 is directed out of the front 240 of lamp 200. As with the first embodiment, the lamp 200 may be fitted with conventional fluorescent bi-pin ends caps (not shown) to provide an electrical interface that is compatible with existing fluorescent lamp fixtures. Additional electronics may also be provided within the tube or attached to one or both ends of the tube to provide AC-to-DC power conversion, current regulation, etc.

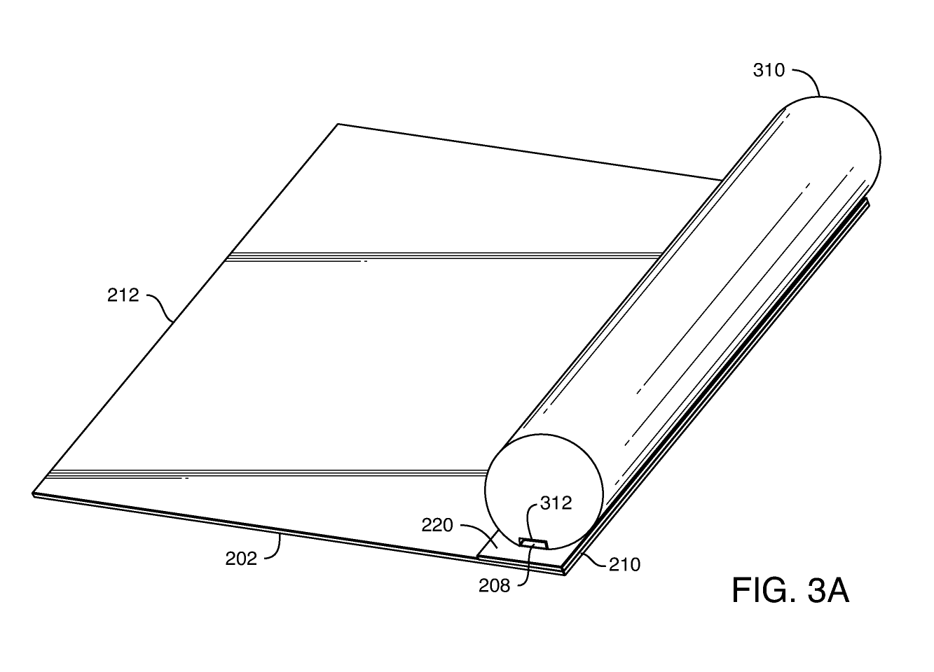

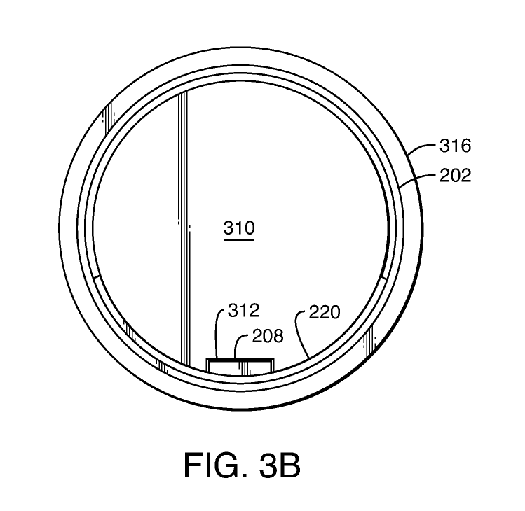

A method of forming a tubular LED lamp in accordance with the second embodiment of this invention is shown in FIGS. 3A and 3B. A cylindrical mandrel 310 having a longitudinal slot 312 is placed lengthwise along the long edge 210 of sheet 202 and over the LEDs 208 protruding through coverlay 220. The longitudinal slot 312 has a height and width sufficient to keep the mandrel 310 from contacting LEDs 208. Sheet 202 is then wrapped around mandrel 312 to form a tube. The whole assembly is then inserted into a copper tube 316 and placed in an oven to thermoform the polymer materials into the desired tubular shape. Preferably, the polymer materials are thermoformed at about 120° C. for about 35 minutes. Once cooled and removed from the copper tube, the long edges 210, 212 may be joined to complete the lamp 200. In particular, the edges may be joined by a number of different techniques including using a mechanical means such as slots in either or both of the long edges, using an adhesive, or by chemical or thermal welding. The edges 201, 212 may also be joined prior to the thermoforming step.

Both of these embodiments would place the underside of the circuit board outside of the tubular enclosure which can be expected to enhance the heat removal from the LED's. Thus at least three advantages may be provided by this type of construction: improved heat removal, improved light output due to a very high reflectance of the circuit board and improved light homogeneity due to the increased distance between the LED and the diffuser surface.

While there have been shown and described what are at present considered to be preferred embodiments of the invention, it will be apparent to those skilled in the art that various changes and modifications can be made herein without departing from the scope of the invention as defined by the appended claims.

What is claimed is:

1. An LED lamp comprising a tubular body having a diffuser portion and a circuit board portion, the circuit board portion having a plurality of light-emitting diodes mounted thereon and electric circuitry for providing power to the LEDs.

2. The LED lamp of claim 1 wherein the diffuser portion and the circuit board portion are integrally formed.

3. The LED lamp of claim 1 wherein the diffuser portion and the circuit board portion have partial circular cross sections and the diffuser is attached to the circuit board portion along longitudinal sides.

4. The LED lamp of claim 4 wherein the longitudinal sides have slots to receive the circuit board portion.

5. The LED lamp of claim 1 wherein the circuit board portion further comprises a coverlay of a highly reflective polymer, the coverlay having holes through which the LEDs protrude.

6. The LED lamp of claim 3 wherein the partial circular cross section of the diffuser portion subtends a central angle of greater than 180°.

7. The LED lamp of claim 3 wherein the partial circular cross section of the circuit board portion subtends a central angle of 120° to 150°.

8. The LED lamp of claim 3 wherein the tubular lamp body comprises a sheet of a translucent polymer material and the circuit board portion comprises a coverlay of a highly reflective polymer material laminated to the sheet of translucent polymer material, the coverlay having holes through which the LEDs protrude and the diffuser portion comprising a region of the translucent sheet not covered by the coverlay.

9. The LED lamp of claim 8 wherein the partial circular cross section of the diffuser portion subtends a central angle of greater than 180°.

10. The LED lamp of claim 8 wherein the partial circular cross section of the circuit board portion subtends a central angle of 120° to 150°.

11. The LED lamp of claim 8 wherein the translucent polymer material and highly reflective polymer material comprise polyethylene terephthalate (PET).

12. The LED lamp of claim 5 wherein the circuit board portion is comprised of polyethylene terephthalate (PET).
